(19) United States
(12) Patent Application Publication
(10) Pub. No.: US 2024/0166843 A1
(43) Pub. Date: May 23, 2024

(54) ELECTROSTATIC DISSIPATIVE POLYAMIDE COMPOSITION AND ARTICLE COMPRISING IT

(71) Applicant: Solvay Specialty Polymers USA, LLC, Alpharetta, GA (US)

(72) Inventors: Chinomso NWOSU, Alpharetta, GA (US); Vijay GOPALAKRISHNAN, Dunwoody, GA (US); Matthew R. VINCENT, Buford, GA (US); Lee CARVELL, Cumming, GA (US); Lindsey ANDERSON, Cumming, GA (US)

(21) Appl. No.: 18/549,632

(22) PCT Filed: Apr. 4, 2022
(86) PCT No.: PCT/EP2022/058900

§ 371 Date: Sep. 8, 2023

Related U.S. Application Data
(60) Provisional application No. 63/171,216, filed on Apr. 6, 2021.

(30) Foreign Application Priority Data
Aug. 5, 2021 (EP) 21189881.2

(51) Int. Cl. C08K 3/04; C08J 3/20; C08J 5/04; C08K 3/013; C08K 3/40; C09C 1/48

(52) U.S. Cl. CPC C08K 3/046; C08J 3/201; C08J 5/042; C08K 3/013; C08K 3/041; C08K 3/40; C09C 1/48; C08K 2201/004; C08K 2201/01; C08K 2201/017

(57) ABSTRACT

Described herein are a polyamide composition and a molded article comprising such polyamide composition, such as a mobile electronic device component. The polyamide composition comprises a polyamide polymer, an electrically conductive material comprising carbon fibers, carbon nano-tubes, or any combination thereof, and a glass filler having tri-dimensional structures characterized by an average length of at most 500 microns, said glass filler comprising at least 20 wt % glass flakes. The polyamide composition and the molded article exhibit near-isotropic mold shrinkage, low warpage and near-isotropic CLTE (Coefficient of Linear Thermal Expansion) and are electrostatic dissipative (ESD).

### CROSS-REFERENCE TO RELATED APPLICATIONS

This application claims priority to U.S. provisional application No. 63/171,216 filed on Apr. 6, 2021 and to European patent application No. 21189881.6 filed on Aug. 5, 2021, the whole content of these applications being incorporated herein by reference for all purposes.

### TECHNICAL FIELD

The present invention relates to electrostatic dissipative polyamide compositions and also to articles including or made from such polymer composition, such as molded articles, particularly mobile electronic device components.

### BACKGROUND

Semi-crystalline polyamides have good mechanical properties and processability, making them well-suited for a variety of applications that require good mechanical performance. Polyamide molded articles are broadly used in the engineering field, in particular for electronic components as well as components in the automotive field. Due to the demand for molded articles with a reduced weight but a high mechanical strength, these articles are in general reinforced by fillers, in particular fibrous fillers. Polyphthalamides in particular are regarded for their high temperature performance, which stems from their high glass transition temperature Tg and high melting temperature Tm.

However, semi-crystalline polyamides exhibit anisotropic mold shrinkage as a result of crystallization, and fibrous reinforcing fillers, like glass fibers, amplify this effect. Additionally, dimensional stability, such as coefficient of linear thermal expansion “CLTE”, or expansion with moisture absorption, is also anisotropic, arising from the semi-crystalline polymer morphology and high aspect ratio of the reinforcing fillers.

Polyamides, like most plastic resins, are insulating materials. Indeed, plastic resins are often considered for use as electrical insulating materials, because they typically do not readily conduct electrical current and are generally rather inexpensive relative to other known insulating materials. A number of known plastics are sufficiently durable and heat resistant to provide at least some electrical insulating utility, but many such plastics are problematic due to the accumulation of electrostatic charge on the surface of the material.

Such surface charge accumulation can be undesirable for various reasons. Such materials sometimes discharge very quickly, and this can damage electronic components, or cause fires or explosions, depending upon the environment. Sudden static discharge can also be an annoyance to those using the material.

Even where sudden static discharge is not a problem, dust will typically be attracted to and will accumulate on materials carrying a static charge. Furthermore, the static charge can interfere with sensitive electronic components or devices and the like.

Resistivity can be defined as involving surface resistivity and volume resistivity. If the volume resistivity is in an appropriate range, an alternative pathway is provided through which a charge can dissipate (generally along the surface). Indeed, surface resistivity is typically the primary focus for electrostatic dissipating (“ESD”) polymeric materials.

Surface resistivity is an electrical resistance measurement (typically measured in ohms per square or “Ω/sq”) taken at the surface of a material at room temperature. Where the surface resistivity is less than or equal to about 10⁵ Ω/sq, the composition's surface has very little insulating ability and is generally considered to be electrically conductive. Such compositions are generally poor electrostatic dissipating polymeric materials, because the rate of bleed off is too high.

Where the surface resistivity is greater than 10¹² Ω/sq, the composition's surface is generally considered to be an insulator. In certain applications, such a composition is also poor electrostatic dissipating material, because the surface does not have the requisite amount of electrical conductivity necessary to dissipate static charge. Typically where the surface resistivity is about 10⁵ to 10¹² Ω/sq, any charge contacting the surface will readily dissipate or “decay”. Further information involving the evaluation of surface and volume resistivity can be found in American Standard Test Method D257. Polymer compositions can be made electrically conductive by adding electrically conductive additives. These electrically conductive additives may include carbon fiber, carbon black, carbon nanotubes, graphene, or graphite. These electrically conductive additives can also include surfactants, salts, conductive organic polymers, and conductive inorganic polymers.

### SUMMARY

An objective of the present invention is thus to provide a polyamide composition which is used to make a polyamide-based article, preferably molded article, having electrostatic dissipative (ESD) properties and suitable dimensional stability. This combination of properties makes such article well-suited for electronic applications, and in particular well-suited for a mobile electronic device component with stringent dimensional tolerances and that require ESD properties for optimal functionality.

The invention solves the problem of anisotropic mold shrinkage and dimensional changes (low warpage) in polyamide-based molded articles (such as components of mobile electronic devices) which have very tight dimensional tolerances. By “warpage” is meant the deformation of molded parts in one or more directions that may be caused by anisotropic shrinkage of the resin during molding.

The invention also solves the problem of poor electrostatic dissipation in a polyamide-based article or device accumulating static charges generated during its operation by facilitating the slow dissipation of these electrostatic charges. Without an electrically conductive material, the polyamide-based article or device would be insulating and no charge dissipation would take place. On the other end, with too much electrically conductive material, the polyamide-based article or device has too low resistivity (too conductive), thereby resulting in grounding of the article or device which may inhibit its performance.

A first aspect of the present invention is directed to a polyamide composition comprising a polyamide polymer, an electrically conductive material and a glass filler having tri-dimensional structures characterized by an average length of at most 500 microns.

The polyamide composition comprises:
at least 20 weight percent (wt %) of a polyamide polymer,
from more than 1 wt % and up to 20 wt % of an electrically conductive material comprising carbon fibers, carbon nanotubes, or any combination thereof, and
from 20 wt % to 60 wt % of a glass filler having tri-dimensional structures characterized by an average length of at most 500 microns, said glass filler comprising at least 20 wt % of glass flakes,

wherein the wt % are based on the total weight of the polyamide composition.

A particular polyamide composition comprises:
at least 20 weight percent (wt %) of a polyamide polymer,
from more than 1 wt % and up to 20 wt % of a carbon-based electrically conductive material comprising carbon fibers, carbon nanotubes, or any combination thereof, and
from 30 wt % to 55 wt % of a glass filler consisting of glass flakes, wherein the wt % are based on the total weight of the polyamide composition.

The polyamide composition may further comprise an optional reinforcing agent, which is different than the glass filler, and/or optional additives, e.g., a heat stabilizer, a lubricant, an impact modifier, a UV stabilizer, a pigment, etc.

A second aspect of the present invention pertains to a method for making the polyamide composition according to the invention, said method comprising melt-blending the polyamide polymer, the electrically conductive material, the glass filler, an optional reinforcing agent different than the glass filler, and optional additives, e.g., a heat stabilizer, a lubricant, an impact modifier, a UV stabilizer, a pigment, etc.

A third aspect of the present invention pertains to a molded article comprising or made from the polyamide composition according to the invention.

A fourth aspect of the present invention pertains to an electronic device component comprising or made from the polyamide composition according to the invention, preferably a mobile electronic device component.

A fifth aspect of the present invention pertains to the use of the polyamide composition according to the invention to make a molded article, such as a mobile electronic device component.

Another aspect of the present invention relates to a method for reducing the surface or volume resistivity of a polyamide-based molded article and also reducing its mold shrinkage and/or warpage, comprising blending the polyamide polymer with the electrically conductive material, the glass filler, and optionally additives, to form a molding composition before subjecting the molding composition to molding, preferably injection molding, to form the molded article.

The various aspects, advantages, and features of the invention will be more readily understood and appreciated by reference to the detailed description and examples.

### Definitions

In the present descriptive specification, some terms are intended to have the following meanings.

As used herein, polyamides are generally obtained by polycondensation between at least one aromatic or aliphatic saturated diacid and at least one aliphatic saturated or aromatic primary diamine, a lactam, an amino-acid or a mixture of these different monomers.

As used herein, a polyphthalamide (PPA) is generally obtained by polycondensation between at least one diacid and at least one diamine in which at least 55 mol % of the diacid portion of the repeating unit in the polymer chain is terephthalic acid and/or isophthalic acid, and in which the diamine is aliphatic.

As used herein, an aliphatic polyamide polymer includes at least 50 mol % of a recurring unit which has an amide bond (—NH—CO—) and is free of any aromatic groups. Put another way, both the diacid portion and the diamine, lactam or amino acid portion forming the polyamide's recurring units through polycondensation are free of any aromatic groups.

As used herein, a ‘semi-crystalline’ polyamide comprises a heat of fusion (“ΔH_{f}”) of at least 5 Joules per gram (J/g) measured using differential scanning calorimetry at a heating rate of 20° C./min. Similarly, as used herein, an amorphous polyamide comprises a ΔH_{f} of less than 5 J/g g measured using differential scanning calorimetry at a heating rate of 20° C./min. ΔH_{f} can be measured according to ASTM D3418. In some embodiments, the ΔH_{f} is at least 20 J/g, or at least 30 J/g or at least 40 J/g.

As used herein, when referring to “glass transition temperature”, Tg, and “melting temperature”, Tm, for the polyamide in the polyamide composition, the Tg and Tm are preferably measured according to ASTM D3418, unless stated otherwise.

The term “nano” as used herein associated with tri-dimensional structures e.g., tubes, sheets, flakes, dics, spheres, or any other 3-D structures, refers to structures having at least one dimension smaller than about 0.1 micrometer (<100 nanometers) and an aspect ratio from longest dimension to shortest dimension from about 50:1 to about 5000:1. The dimensions of nano 3-D structures can be determined by Dynamic Light Scattering (DSL) and/or direct measurement on micrographs obtained by Scanning Electron Microscopy (SEM).

In the present specification, the choice of an element from a group of elements also explicitly describes:
the choice of two or the choice of several elements from the group,
the choice of an element from a subgroup of elements consisting of the group of elements from which one or more elements have been removed.

In the passages of the present specification which will follow, any description, even though described in relation to a specific embodiment, is applicable to and interchangeable with other embodiments of the present disclosure. Each embodiment thus defined may be combined with another embodiment, unless otherwise indicated or clearly incompatible. In addition, it should be understood that the elements and/or the characteristics of a composition, a component or article, a process, a method or a use, described in the present specification, may be combined in all possible ways with the other elements and/or characteristics of the composition, component or article, process, method or use, explicitly or implicitly, this being done without departing from the scope of the present description.

In the present specification, the description of a range of values for a variable, defined by a bottom limit, or a top limit, or by a bottom limit and a top limit, also comprises the embodiments where the variable is chosen, respectively, within the range of values: excluding the bottom limit, or excluding the top limit, or excluding the bottom limit and the top limit. Any recitation herein of numerical ranges by endpoints includes all numbers subsumed within the recited ranges as well as the endpoints of the range and equivalents.

The term “comprising” (or “comprise”) includes “consisting essentially of” (or “consist essentially of”) and also “consisting of” (or “consist of”). As used herein, “consist essentially of” with respect to a composition means that the content of component(s) not explicitly recited in the composition is less than 1 wt %, or less 0.5 wt %, or less than 0.1 wt %, or less than 0.05 wt %, or less than 0.01 wt %, said wt % being based on the total weight of the composition.

The use of the singular “a” or “one” herein includes the plural unless specifically stated otherwise.

### DETAILED DESCRIPTION OF PREFERRED EMBODIMENTS

When the polyamide composition according to the invention comprises the polyamide polymer, the electrically conductive material, the glass filler, optional reinforcing agent(s) different than the glass filler, and optional additives, it was surprisingly found that the resulting polyamide composition yields a polyamide-based molded article with electrostatic dissipative properties, improved dimensional stability (CLTE) and improved shrinkage and/or warpage properties while exhibiting suitable mechanical performance.

A molded article containing or made from such polyamide composition according to the invention exhibits near-isotropic mold shrinkage and/or low warpage and near-isotropic CLTE (Coefficient of Linear Thermal Expansion). Additionally, the volume resistivity is such that the molded article containing or made from such polyamide composition according to the invention is electrostatic dissipative (ESD). This combination makes the polyamide composition according to the invention well-suited for electronic applications with stringent dimensional tolerances and that require ESD properties for optimal functionality. Preferably, the molded article containing or made from such polyamide composition according to the invention is an electronic device component.

In some embodiments, the polyamide-based molded article or the electronic device component has a volume resistivity (measured according to ASTM D257) of at least 1·10⁺⁵ Ω·cm, or at least 1.5·10⁺⁵ Ω·cm, and/or of at most 5·10⁺¹² Ω·cm, or at most 3·10⁺¹² Ω·cm, or at most 1·10⁺¹² Ω·cm. In some embodiments, the polyamide-based molded article or the electronic device component has a volume resistivity of from 1·10⁺⁵ Ω·cm up to 5·10⁺¹² Ω·cm. The volume resistivity is therefore tunable over about at least 7 orders of magnitude by selecting the conductive material with a specific volume resistivity and varying the electrically conductive material content in the polyamide composition used to make the molded article.

In some embodiments, the polyamide-based molded article or the electronic device component according to the invention has a mold shrinkage (in %) in transverse direction, determined according to ISO 294 (ASTM D955), of at most 0.5%, or at most 0.47%, or at most 0.45%, or at most 0.44%.

In some embodiments, the polyamide-based molded article or the electronic device component according to the invention has a ratio of mold shrinkage in flow direction versus mold shrinkage in transverse direction is greater than 32%, or greater than 35%, or greater than 40%, or greater than 45%, or greater than 50%, or greater than 55%, or greater than 60%, wherein the mold shrinkages (in %) in flow direction and in transverse direction are determined according to ISO 294 (ASTM D955).

In some embodiments, the polyamide-based molded article or the electronic device component according to the invention has a warpage of at most 0.5, or at most 0.4, or at most 0.3, or at most 0.2, or at most 0.18. The warpage is the absolute value of the percent shrinkage in the transverse direction minus the percent shrinkage in the flow direction of a molded article or the electronic device component comprising the polyamide composition, both of % shrinkages being preferably determined according to ASTM D955.

In some embodiments, the polyamide-based molded article or the electronic device component according to the invention, resulting from molding the polyamide composition comprising 20 wt % of at least one polyamide polymer, from more than 1 wt % to 20 wt % of the electrically conductive material, at least 20 wt % of glass flakes as at least a glass filler, optionally reinforcing agent(s) and optionally additives (e.g., a heat stabilizer, a lubricant, an impact modifier, a UV stabilizer, a pigment, etc) has a lower warpage (in %) compared to a similar composition but in which the glass flakes are replaced by a glass fiber.

In some embodiments, the polyamide composition according to the invention does not comprise more than 5 wt %, preferably does not comprise more than 2 wt %, more preferably does not comprise more than 1 wt %, of a polymer other than polyamide polymer(s).

In some embodiments, the polyamide composition according to the invention consists essentially of the polyamide polymer, the electrically conductive material, the glass filler, optionally reinforcing agent(s) different than the glass filler, and optionally additives, e.g., a heat stabilizer, a lubricant, an impact modifier, a UV stabilizer, a pigment, etc, as described herein. The term “consists essentially” with respect to the polyamide composition means that the content of component(s) not explicitly described in the composition is less than 1 wt %, or less 0.5 wt %, or less than 0.1 wt %, or less than 0.05 wt %, or less than 0.01 wt %, said wt % being based on the total weight of the polyamide composition.

### Polyamide Polymer

The polyamide composition comprises at least 20 wt % of at least one polyamide polymer, based on the total weight of the polyamide composition.

The polyamide polymer in the polyamide composition may include a semi-aromatic polyamide. In such instances, the polyamide polymer in the polyamide composition may include a semi-aromatic polyamide selected from the group consisting of PA10T/10I; PA10T; PA6T/6I; PA6T; PA9T; PA12T; PA10T/66; PA6T/66; PA6,I; PA12I; PAMXD6; PAPXD10; and any combination thereof.

The polyamide polymer in the polyamide composition may include, or consist essentially of, at least one polyphthalamide. In such instances, the polyamide polymer in the polyamide composition may include, or consist essentially of, at least one polyphthalamide selected from the group consisting of PA10T/10I; PA10T; PA6T/6I; PA6T; PA9T; PA12T; PA10T/66; PA6,I; PA12I; and any combination thereof.

The polyamide polymer in the polyamide composition may include an aliphatic polyamide. In such instances, the polyamide polymer in the polyamide composition may be selected from the group consisting of PA610; PA612; PA1010; PA12; PA510; PA66; PA1012; and any combination thereof.

The content of the at least one polyamide polymer in the polyamide composition is at least 20 wt %, or at least 25 wt %, or at least 30 wt %, based on the total weight of the polyamide composition.

The content of the polyamide polymer in the polyamide composition may be at most 89.9 wt %, or at most 85 wt %, or at most 80 wt %, or at most 75 wt %, or at most 70 wt %, or at most 65 wt %, based on the total weight of the polyamide composition.

In some embodiments, the polyamide composition may include a plurality of distinct polyamide polymers according to the above description. In such instances, the total content of distinct polyamide polymers is within the ranges described above. A particular example of such embodiments is when the polyamide polymer comprises, or consists essentially of, a combination of PA6,10 and PAMDX6. Another example of such embodiments is when the polyamide polymer comprises, or consists essentially of, a combination of PA10T/10I and PAMDX6. PAMXD6 polymer is a polymer made from adipic acid and meta-xylylene diamine (notably commercially available as IXEF® polyarylamides from Solvay Specialty Polymers U.S.A. L.L.C.).

One of the polyamide polymers (e.g., a PAMXD6 polymer) in the polyamide composition may be a polymeric carrier to form a masterbatch into which an additive or/and the electrically conductive material is/are mixed prior to making the polyamide composition. In such instance, the weight content (wt %) of such polyamide (e.g., PAMXD6) used as masterbatch polymeric carrier should be less than the weight content (wt %) of the other polyamide(s), their respective wt % being based on the total weight of the polyamide composition.

The polyamide polymer may comprise at least one semi-aromatic polyamide and at least one aliphatic polyamide. In such instances, the weight ratio of the at least one semi-aromatic polyamide based on the combined weight of the distinct polyamides in the polyamide composition may be lower than the weight ratio of the at least one aliphatic polyamide based on the combined weight of the distinct polyamides in the polyamide composition.

In some embodiments, the polyamide composition may not comprise an aromatic polyamide.

In alternate embodiments, the polyamide composition may not comprise an aliphatic polyamide.

The polyamide composition may exclude a polyamide made from a single monomer, such as PA6.

The polyamide composition may exclude a polyamide made from two monomers which comprise 6 carbons or less, such as PA66.

The polyamide polymer is preferably a semi-crystalline polyamide.

At least a portion of the polyamide polymer in the polyamide composition may be bio-based.

The polyamide composition may comprise any polyamide which has a Tg less than 80° C. and/or a Tm less than 250° C.

Alternatively, the polyamide composition may comprise a polyamide polymer having a Tg of at least 80° C., at least 95° C., or at least 100° C.

The polyamide polymer may have a Tg of no more than 200° C., no more than 180° C., no more than 160° C., no more than 150° C., no more than 140° C., or no more than 135° C. In such instance, the polyamide polymer may have a Tg of from 80° C. to 150° C., from 100° C. to 140° C., or from 100° C. to 135° C.

The polyamide polymer may have a melting temperature Tm of at least 230° C., at least 260° C., or at least 265° C. The polyamide polymer may have a Tm of no more than 360° C., no more than 350° C., or no more than 340° C., or no more than 330° C. In such instance, the polyamide polymer may have a Tm of from 230° C. to 360° C., from 260° C. to 350° C., or from 265° C. to 330° C. Tg and Tm can be measured according to ASTM D3418.

### Electrically Conductive Material

The polyamide composition also comprises more than 1 wt % and up to 20 wt % of at least one electrically conductive material comprising carbon fibers, carbon nanotubes, or any combination thereof. The electrically conductive material provides for improved ESD of the polyamide composition and of the article or device made from the polyamide composition or into which the polyamide composition is incorporated.

The electrically conductive material preferably has a volume resistivity of less than 2·10⁻² Ω·cm, or at most 1·10⁻² Ω·cm, or at most 5·10⁻³ Ω·cm, or at most 3·10⁻³ Ω·cm, or at most 2·10⁻³ Ω·cm. The electrically conductive material preferably has a volume resistivity of at least 1·10⁻⁴ Ω·cm. The electrically conductive material may have a volume resistivity of from 1·10⁻⁴ Ω·cm up to 20·10⁻⁴ Ω·cm.

The electrically conductive material may have a specific surface area (SSA) of at least 0.1 m²/g, preferably 10 m²/g or higher, for example from about 10 m²/g to about 500 m²/g as measured by standard Brunauer-Emmett-Tellermethod (BET) measurement method. For example the BET measurement method with a Micro-metrics TriStar II with the standard nitrogen system may be used.

The electrically conductive material may comprise, or consist essentially of, carbon-based structures selected from the group consisting of: metalized carbon fibers, chopped carbon fibers, milled carbon fibers, milled/chopped carbon fibers in granulates, carbon nanotubes such as single-walled carbon nanotubes (“SWCNT”), double-walled carbon nanotubes (“DWCNT”), multiwalled carbon nanotubes (“MWCNT”) (which consist of nested SWCNT), and any mixture thereof. The electrically conductive material preferably comprises, or consists essentially of, carbon-based structures selected from the group consisting of: chopped carbon fibers, milled carbon fibers, milled/chopped carbon fibers in granulates, carbon nanotubes and any mixture thereof.

Preferred carbon fibers include, but are not limited to, chopped carbon fibers, milled carbon fibers, and/or milled/chopped carbon fibers in granulates.

Preferred chopped carbon fibers compatible with polyamides are commercially available as CF.OS.U1—6 mm, CF.OS. U2—6 mm, CF.OS.A—6 mm, CF.OS.I—6 mm from Procotex, with an average monofilament diameter of 7 microns, a mean length of 6 mm and a volume resistivity of 15·10⁻⁴ Ω·cm up to 20·10⁻⁴ Ω·cm.

Preferred milled carbon fibers are commercially available as CF.LS-MLD80 to CF.LS-MLD250 from Procotex, with an average monofilament diameter of 7 microns, a medium length of 80-250 microns and a volume resistivity of 15·10⁻⁴ Ω·cm up to 20·10⁻⁴ Ω·cm.

Carbon nanotubes are an example of nanometer or molecular size electrically conductive materials. Preferably, the carbon nanotubes are MWCNT. Carbon nanotubes and carbon nano-ropes such as ropes of carbon nanotubes (e.g., SWNT or MWNT and ropes of SWNT or MWNT) exhibit high mechanical strength, electrical conductivity, and high thermal conductivity.

Suitable multi-walled CNTs (MWCNTs) include Nanocyl® NC7000 MWCNT grade having purity as low as 90% C purity or Nanocyl® NC3100 MWCNT grade with a C purity to greater than 95% C purity, both from Nanocyl (Belgium). Nanocyl® NC7000 MWCNTs have an average diameter of 9.5 nanometers, a mean length of 1.5 microns, a BET surface area of 250-300 m²/g and a volume resistivity of 1·10⁻⁴ Ω·cm. Other suitable sources for carbon nanotubes are FRIBIL® multi-walled carbon nanotubes from Hyperion Catalysis International. These MWCNTs may have an outside diameter of about 10 nanometers and a length over 10 microns.

The carbon nanotubes may have an average aspect ratio, defined as the length over the diameter, of 100 or more. The carbon nanotubes can have an average aspect ratio of 1000 or more. The carbon nanotubes may have an average diameter of from 1 nanometer (nm) to 3.5 nm or 4 nm (roping). The carbon nanotubes may have an average length of at least 1 μm.

The electrically conductive material may further comprise other tri-dimensional structure(s) selected from the group consisting of fibers, flakes, powders, microspheres, nano-particles, nano-fibers, nano-flakes, nano-ropes, nano-ribbons, nano-fibrils, nano-needles, nano-sheets, nano-rods, carbon nano-cones, carbon nano-scrolls, nano-platelets, nano-dots, dendrites, discs or any other tri-dimensional body, singly or in combination.

Alternatively or additionally, the electrically conductive material may further comprise at least one material selected from: metal flakes, metal powders, metalized glass spheres, metalized glass fibers, metal fibers, metalized whiskers, intrinsically conductive polymers and/or graphite fibrils.

The electrically conductive material preferably solely comprised of carbon-based structure(s). Carbon-based structures generally comprise at least 90 wt % carbon. Commercially available industrial grades of carbon-based structures or nano-structures with a 90-95% C purity can be dispersed directly in the polyamide polymer without pre-treatment.

In addition to carbon fibers and/or carbon nanotubes, the electrically conductive material may further comprise carbon-based structures selected from: carbon nano-fibres, carbon nano-flakes, carbon nano-ropes, carbon nano-ribbons, carbon nano-fibrils, carbon nano-needles, carbon nano-sheets, carbon nano-rods, carbon nano-cones, carbon nano-scrolls, carbon nano-ohms, conductive carbon black powder, graphite fibrils, graphite nano-platelets, nano-dots, graphenes, or any combination of two or more thereof.

The electrically conductive material preferably comprises, or consists of,
carbon-based structures selected from the group consisting of: carbon fibers, carbon nanotubes (CNTs) such as SWCNTs, DWCNTs and MWCNTs and any combination thereof, and
optionally, ropes of carbon nanotubes, carbon black powder, or any combination thereof.

The electrically conductive material content in the polyamide composition is more than 1 wt %, or at least 1.5 wt % and at most 20 wt %, based on the total weight of the polyamide composition.

When the electrically conductive material comprises carbon fibers, the carbon fibers content in the polyamide composition is at least 6 wt %, or at least 8 wt %, or at least 10 wt %, based on the total weight of the polyamide composition. In such instances, the carbon fibers content is at most 20 wt %, or at most 17 wt %, or at most 15 wt %, based on the total weight of the polyamide composition. The carbon fibers content may be from 6 wt % to 20 wt %, or from 8 wt % to 20 wt %, or from 10 wt % to 20 wt %, or from 6 wt % to 15 wt %, or from 8 wt % to 15 wt %, or from 10 wt % to 20 wt %, or from 10 wt % to 15 wt %, based on the total weight of the polyamide composition.

When the electrically conductive material comprises carbon nanotubes, their content in the polyamide composition is more than1 wt %, or at least 1.5 wt %, based on the total weight of the polyamide composition. In such instances, the content of the carbon nanotubes (CNTs) is at most 8 wt %, or at most 7 wt %, or at most 6 wt %, or at most 5 wt %, or at most 4 wt %, or at most 3 wt %, based on the total weight of the polyamide composition. The content of carbon nanotubes when present in the polyamide composition may be from more than1 wt % and up to 8 wt %, or from more than 1 wt % and up to 5 wt %, or from more than 1 wt % and up to 4 wt %, or from more than 1 wt % and up to 3 wt %, or from 1.5 wt % to 8 wt %, or from 1.5 wt % to 5 wt %, or from 1.5 wt % to 3 wt %, based on the total weight of the polyamide composition.

When the electrically conductive material further comprises carbon black powder, the carbon black powder content in the polyamide composition may be from 0.1 wt %, or at least 0.5 wt %, or at least 1 wt %, based on the total weight of the polyamide composition. In such instances, the carbon black powder content in the polyamide composition is at most 10 wt %, based on the total weight of the polyamide composition.

When the conductive material further comprises other carbon-based nano-structures (other than carbon nanotubes), their content in the polyamide composition may be from 0.1 wt % to 5 wt %, or from 0.1 wt % to 4 wt %, or from 0.1 wt % to 3 wt %, or from 0.5 wt % to 5 wt %, or from 0.5 wt % to 4 wt %, or from 0.5 wt % to 3 wt %, or from 1 wt % to 8 wt %, or from 1 wt % to 5 wt %, or from 1 wt % to 4 wt %, or from 1 wt % to 3 wt %, or from 1.5 wt % to 8 wt %, or from 1.5 wt % to 5 wt %, or from 1.5 wt % to 3 wt %, based on the total weight of the polyamide composition.

### Glass Filler

The polyamide composition also comprises from 20 wt % to 60 wt % of at least one glass filler having tri-dimensional structures characterized by an average length at most 500 microns, or at most 450 microns, or at most 400 microns, or at most 350 microns, or at most 200 microns, or at most 250 microns. For the glass filler having a tri-dimensional structure, its “length” is regarded as its longest dimension. The wt % is based on the total weight of the polyamide composition.

The glass filler is preferably an electrically insulating filler, generally having a volume resistivity of more than 10⁺¹² Ω·cm or more than 5·10⁺¹² Ω·cm.

The glass filler is preferably non-fibrous. A “non-fibrous” filler is considered herein to have a tri-dimensional structure having a length, a width and thickness, wherein both length and width are significantly larger than its thickness. Generally, such glass filler having tri-dimensional structures has an aspect ratio, defined as the average length over the largest of the average width and average thickness, of at most 3, or at most 2.5, or at most 2 or at most 1.5.

The dimensions (length, width, thickness) of tri-dimensional structures can be determined by direct measurement on micrographs obtained by Scanning Electron Microscopy (SEM).

The average dimensions (i.e., length, width and thickness) of the glass filler's tri-dimensional structures can be taken as the average length of the glass filler prior to incorporation into the polyamide composition or can be taken as the average dimensions of the glass filler in the polyamide composition.

Glass fillers are silica-based glass compounds that contain several metal oxides which can be tailored to create different types of glass. The main oxide is silica in the form of silica sand: the other oxides such as calcium, sodium and aluminum are incorporated to reduce the melting temperature and impede crystallization. Any glass type, such as A, C, D, E, M, S, R, T glass or mixtures thereof, preferably C or E glass, may be used in the glass filler. C glass contains alkali components and has high acid resistance. E glass contains almost no alkali and so, it has high stability in resin and no electrical conductivity.

The glass filler comprises at least 20 wt % of glass flakes, based on the total weight of the polyamide composition.

The glass filler may consist essentially of glass flakes, such that the polyamide composition comprises from 20 wt % to 60 wt % of glass flakes, preferably from 30 wt % to 55 wt % of glass flakes, based on the total weight of the polyamide composition.

The glass flakes may be glass flakes with C or E glass. Suitable glass flakes with E or C glass are commercially available as GLASFLAKE® from NSG. E-glass flakes are particularly effective in preventing warpage and improving dimensional accuracy in precision parts made of thermoplastic polymers. FINEFLAKE® glass flakes also commercially available from NSG with an average thickness of 0.4 to 1 microns are suitable for fine and thin molded products. The glass flakes may be granulated. For example, FLEKA® granulated glass flakes with E glass are commercially available from NSG.

The glass flakes may have an average thickness of from 0.4 micron to 10 microns. In some embodiments, the glass flakes may have an average thickness of from 0.4 micron up to 2 microns, or up to 1 micron.

The glass filler may further include chopped glass fibers, so long as their average length is at most 500 microns, or at most 450 microns, or at most 400 microns, or at most 350 microns, or at most 200 microns, or at most 250 microns.

In instances when the glass filler include both glass flakes and chopped glass fibers which are both characterized by an average length at most 500 microns, or at most 450 microns, or at most 400 microns, or at most 350 microns, or at most 200 microns, or at most 250 microns, their combined amounts do not exceed 60 wt % based on the total weight of the polyamide composition.

Furthermore, when the glass filler include both glass flakes and chopped glass fibers, the glass flakes preferably represent a weight fraction of more than 50 wt %, or more than 60 wt %, or more than 70 wt %, or more than 80 wt % of the glass filler (this weight fraction in wt % being based on the combined weight of glass flakes and chopped glass fibers). As an example, should the glass flakes content in the polyamide composition be 30 wt %, the chopped glass fibers content should be less than 30 wt % (based on the total weight of the polyamide composition).

The chopped glass fibers when present in the glass filler may generally have a thickness of from 5 to 20 μm, preferably of from 5 to 15 μm and more preferably of from 5 to 10 μm. The chopped glass fibers may have an average length of at least 50 microns, or at least 100 microns, or at least 150 microns, or at least 200 microns, or at least 250 microns. The chopped glass fibers may have an average length of from 100 to 500 microns, or from 150 to 450 microns.

The chopped glass fibers may have an aspect ratio, defined as their average length over the largest of their average width and average thickness, of at most 5, or at most 3, or at most 2.5, or at most 2, or at most 1.5.

The morphology of the chopped glass fiber is not particularly limited. The chopped glass fiber can have a circular cross-section (“round glass fiber”) or a non-circular cross-section (“flat glass fiber”). Examples of suitable flat glass fibers include, but are not limited to, glass fibers having oval, elliptical and rectangular cross sections.

In instances when the glass filler further comprises chopped flat glass fibers, the flat glass fibers has an average width (cross-sectional longest dimension) of at least 15 μm, preferably at least 20 μm, more preferably at least 22 μm, still more preferably at least 25 μm. Additionally or alternatively, in some embodiments, the chopped flat glass fibers have an average width (cross-sectional longest diameter) of at most 40 μm, preferably at most 35 μm, more preferably at most 32 μm, still more preferably at most 30 μm. The chopped flat glass fibers may have an average width (cross-sectional longest diameter) in the range of 15 to 35 μm, preferably of 20 to 30 μm and more preferably of 25 to 29 μm. The chopped flat glass fibers may have a thickness (cross-sectional shortest diameter) of at least 4 μm, preferably at least 5 μm, more preferably at least 6 μm, still more preferably at least 7 μm. Additionally or alternatively, the chopped flat glass fibers may have a thickness (cross-sectional shortest diameter) of at most 25 μm, preferably at most 20 μm, more preferably at most 17 μm, still more preferably at most 15 μm. The chopped flat glass fibers may have a thickness (cross-sectional shortest diameter) in the range of 5 to 20, preferably of 5 to 15 μm and more preferably of 7 to 11 μm.

The chopped flat glass fibers may have a ratio of the width (longest diameter in the cross-section) of the glass fiber to the thickness (shortest diameter in the same cross-section) of at least 2, preferably at least 2.2, more preferably at least 2.4, still more preferably at least 3. Additionally or alternatively, the chopped flat glass fibers may have a ratio of the width (longest diameter in the cross-section) of the glass fiber to the thickness (shortest diameter in the same cross-section) of at most 8, preferably at most 6, more preferably of at most 4. The chopped flat glass fibers may have a ratio of the width (longest diameter in the cross-section) of the glass fiber to the thickness (shortest diameter in the same cross-section) of from 2 to 6, and preferably, from 2.2 to 4.

The glass filler content in the polyamide composition is at least 20 wt %, or at least 25 wt %, or at least 30 wt %, based on the total weight of the polyamide composition. The glass filler content is at most 60 wt %, or at most 55 wt %, or at most 50 wt %, based on the total weight of the polyamide composition. The glass filler content in the polyamide composition is from 20 wt % to 60 wt %, or may be from 25 wt % to 60 wt %, or from 30 wt % to 60 wt %, or from 20 wt % to 55 wt %, or from 25 wt % to 55 wt %, or from 30 wt % to 55 wt %, or from 20 wt % to 50 wt %, or from 25 wt % to 50 wt %, or from 30 wt % to 50 wt %, based on the total weight of the polyamide composition.

The polyamide composition comprises at least 20 wt %, or at least 25 wt %, or at least 30 wt % glass flakes, based on the total weight of the polyamide composition. The polyamide composition comprises at most 60 wt %, or at most 55 wt %, or at most 50 wt % of glass flakes, based on the total weight of the polyamide composition.

The glass flakes content in the polyamide composition may be from 20 wt % to 60 wt %, or from 25 wt % to 60 wt %, or from 30 wt % to 60 wt %, or from 20 wt % to 55 wt %, or from 25 wt % to 55 wt %, or from 30 wt % to 55 wt %, or from 20 wt % to 50 wt %, or from 25 wt % to 50 wt %, or from 30 wt % to 50 wt %, based on the total weight of the polyamide composition.

### Optional Reinforcing Agent

The polyamide composition may further comprise at least one optional reinforcing agent which is different than the glass filler, as described above.

A large selection of reinforcing agents, also called reinforcing fillers, may be added optionally to the polyamide composition according to the present invention. They can be selected from fibrous and particulate reinforcing agents.

The optional reinforcing agent may be selected from mineral fillers (such as talc, mica, kaolin, calcium carbonate, calcium silicate, magnesium carbonate), carbon fibers, synthetic polymeric fibers, aramid fibers, aluminum fibers, titanium fibers, magnesium fibers, boron carbide fibers, rock wool fibers, steel fibers, wollastonite, glass balls (e.g., hollow glass microspheres), and glass fibers, different than the glass filler used in the polyamide composition according to the invention.

A particulate reinforcing agent may be selected from mineral fillers (such as talc, mica, kaolin, calcium carbonate, calcium silicate, magnesium carbonate) or glass balls (e.g., hollow glass microspheres).

A fibrous reinforcing filler is considered herein to be a tri-dimensional material having length, width and thickness, wherein the average length is significantly larger than both the width and thickness. Generally, such a material has an aspect ratio, defined as the ratio between the average length and the largest of the average width and average thickness of at least 5, at least 10, at least 20 or at least 50.

The optional reinforcing fibers (e.g., glass fibers) may be chopped glass fibers (different than the glass filler) having an average length greater than 0.5 mm, preferably of at least 1 mm, and up to 50 mm, or continuous glass fibers. The average length of the optional reinforcing glass fibers can be taken as the average length of the reinforcing glass fibers prior to incorporation into the polyamide composition or can be taken as the average length of the reinforcing fiber in the polyamide composition.

The optional glass fibers may have an average length of from 3 mm to 50 mm, or from 3 mm to 10 mm, from 3 mm to 8 mm, from 3 mm to 6 mm, or from 3 mm to 5 mm. Alternatively, the optional glass fibers may have an average length of from 10 mm to 50 mm, from 10 mm to 45 mm, from 10 mm to 35 mm, from 10 mm to 30 mm, from 10 mm to 25 mm or from 15 mm to 25 mm. In such instances, the optional glass fibers may have generally an equivalent diameter of from 5 to 20 μm, preferably of from 5 to 15 μm and more preferably of from 5 to 10 μm.

All glass types, such as A, C, D, E, M, S, R, T glass or any mixtures thereof or mixtures thereof may be used. E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminium and magnesium. In particular, those glass fibers comprise typically from 62-75 wt. % of SiO₂, from 16-28 wt. % of Al₂O₃ and from 5-14 wt. % of MgO. On the other hand, R, S and T glass fibers comprise less than 10 wt. % of CaO.

The optional glass fiber may include or consist of a high modulus glass fiber. High modulus glass fibers have an elastic modulus of at least 76 GPa, preferably at least 78 GPa, more preferably at least 80 GPa, and most preferably at least 82 GPa as measured according to ASTM D2343. Examples of high modulus glass fibers include, but are not limited to, S, R, and T glass fibers. A commercially available source of high modulus glass fibers is S-1 and S-2 glass fibers from Taishan and AGY, respectively.

The optional glass fiber may include or consist of a round glass fiber or flat glass fiber. Examples of suitable flat glass fibers include, but are not limited to, glass fibers having oval, elliptical and rectangular cross sections.

When the polyamide composition further includes a flat glass fiber, the flat glass fiber may have a cross-sectional longest diameter of at least 15 μm, preferably at least 20 μm, more preferably at least 22 μm, still more preferably at least 25 μm. Additionally or alternatively, the flat glass fiber may have a cross-sectional longest diameter of at most 40 μm, preferably at most 35 μm, more preferably at most 32 μm, still more preferably at most 30 μm. In some embodiments, the flat glass fiber may have a cross-sectional shortest diameter of at least 4 μm, preferably at least 5 μm, more preferably at least 6 μm, still more preferably at least 7 μm. Additionally or alternatively, the flat glass fiber may have a cross-sectional shortest diameter of at most 25 μm, preferably at most 20 μm, more preferably at most 17 μm, still more preferably at most 15 μm.

The optional flat glass fiber may have a ratio of the longest diameter in the cross-section of the glass fiber to the shortest diameter in the same cross-section of at least 2, preferably at least 2.2, more preferably at least 2.4, still more preferably at least 3. Additionally or alternatively, this ratio of the flat glass fiber may be at most 8, preferably at most 6, more preferably of at most 4.

When the optional glass fiber is a round glass fiber, the glass fiber may have a ratio of the longest diameter in the cross-section of the glass fiber to the shortest diameter in the same cross-section of less than 2, preferably less than 1.5, more preferably less than 1.2, even more preferably less than 1.1, most preferably, less than 1.05. Of course, the person of ordinary skill in the art will understand that regardless of the morphology of the glass fiber (e.g., round or flat), the aspect ratio cannot, by definition, be less than 1.

The optional glass fiber may be a round or flat glass fiber selected from the group consisting of: E-glass fiber: high modulus glass fiber having a tensile modulus of at least 76 GPa as measured according to ASTM D2343: and combinations thereof.

When the polyamide composition includes the glass filler and at least one optional reinforcing agent according to the above description, the combined content of the glass filler + optional reinforcing agent(s) is at least 15 wt %, or at least 20 wt %, or at least 25 wt %, or at least 30 wt %, based on the total weight of the polyamide composition. In additional or alternate embodiments, the combined content of the glass filler + optional reinforcing agent(s) is at most 60 wt %, or at most 55 wt %, or at most 50 wt %, based on the total weight of the polyamide composition. In some embodiments, the combined content of the glass filler + optional reinforcing agent(s) is from 15 wt % to 60 wt %, or from 20 wt % to 60 wt %, or from 25 wt % to 60 wt %, or from 30 wt % to 60 wt %, or from 20 wt % to 55 wt %, or from 25 wt % to 55 wt %, or from 30 wt % to 55 wt %, or from 20 wt % to 50 wt %, or from 25 wt % to 50 wt %, or from 30 wt % to 50 wt %, based on the total weight of the polyamide composition.

When the polyamide polymer comprises the glass filler + optional reinforcing agent(s), the weight ratio of the glass filler based on the combined weight of the glass filler + optional reinforcing agent(s) in the polyamide composition is greater than the weight ratio of the optional reinforcing agent(s), based on the combined weight of the glass filler + optional reinforcing agent(s) in the polyamide composition.

The polyamide composition preferably excludes fibrous reinforcing agents.

The polyamide composition preferably excludes glass fibers having an average length greater than 0.5 mm, or greater than 1 mm.

The polyamide composition preferably excludes glass spheres or balls and in particular excludes hollow glass balls.

The polyamide composition preferably excludes a reinforcing agent which is different than the glass filler, as described above.

### Optional Additives

Optionally, the polyamide composition may further include an additive selected from the group consisting of tougheners, plasticizers, light stabilizers, ultra-violet (“UV”) stabilizers, heat stabilizers, pigments, dyes, antistatic agents, flame retardants, impact modifiers, lubricants, nucleating agents, antioxidants, processing aids, and any combination of two or more thereof.

When the polyamide composition includes one or more optional additives, the total concentration of additives is no more than 15 wt %, no more than 10 wt %, no more than 5 wt %, no more than 3 wt %, no more 2 wt %, no more than 1 wt %, and/or at least 0.1 wt %, or at least 0.2 wt %, or at least 0.3 wt %.

In particular, the polyamide composition may further include at least one impact modifier, heat stabilizer and/or lubricant.

Impact modifiers useful herein are not particularly limited, so long as they impart useful properties to the polyamide composition, such as sufficient tensile elongation at yield and break. For example, any rubbery low-modulus functionalized polyolefin impact modifier with a glass transition temperature lower than 0° C. is suitable for this invention. Useful impact modifiers include polyolefins, preferably functionalized polyolefins, and especially elastomers such as SEBS and EPDM.

Useful functionalized polyolefin impact modifiers are available from commercial sources, including maleated polypropylenes and ethylene-propylene copolymers available as EXXELOR™ PO and maleic anhydride-functionalized ethylene-propylene copolymer rubber comprising about 0.6 weight percent pendant succinic anhydride groups, such as EXXELOR® RTM. VA 1801 from the Exxon Mobil Chemical Company: acrylate-modified polyethylenes available as SURLYN®, such as SURLYN® 9920, methacrylic acid-modified polyethylene from the DuPont Company: and PRIMACOR®, such as PRIMACOR® 1410 XT, acrylic acid-modified polyethylene, from the Dow Chemical Company; maleic anhydride-modified styrene-ethylene-butylene-styrene (SEBS) block copolymer, such as KRATON® FG1901 GT or FG1901 X, a SEBS that has been grafted with about 2 weight % maleic anhydride, available from Kraton Polymers: maleic anhydride-functionalized ethylene-propylene-diene monomer (EPDM) terpolymer rubber, such as ROYALTUF® 498, a 1% maleic anhydride functionalized EPDM, available from the Crompton Corporation.

Other functionalized impact modifiers that may also be used in the practice of the invention include ethylene-higher alpha-olefin polymers and ethylene-higher alpha-olefin-diene polymers that have been provided with reactive functionality by being grafted or copolymerized with suitable reactive carboxylic acids or their derivatives such as, for example, acrylic acid, methacrylic acid, maleic anhydride or their esters, and will have a tensile modulus up to about 50,000 psi determined according to ASTM D-638. Suitable higher alpha-olefins include C₃ to C₈ alpha-olefins such as, for example, propylene, butene-1, hexene-1 and styrene. Alternatively, copolymers having structures comprising such units may also be obtained by hydrogenation of suitable homopolymers and copolymers of polymerized 1-3 diene monomers. For example, polybutadienes having varying levels of pendant vinyl units are readily obtained, and these may be hydrogenated to provide ethylene-butene copolymer structures. Similarly, hydrogenation of polyisoprenes may be employed to provide equivalent ethylene-isobutylene copolymers. The functionalized polyolefins that may be used in the present invention include those having a melt index in the range of about 0.5 to about 200 g/10 min.

In preferred embodiments, the polyamide composition does not comprise an antistatic agent.

### Preparation of the Polyamide Composition

The invention further pertains to a method for making the polyamide composition as above detailed, said method comprising melt-blending the at least one polyamide polymer, the conductive material, the glass filler, optional reinforcing agent(s) different than the glass filler, and any other optional additives, e.g., a lubricant, a UV stabilizer, a heat stabilizer, an impact modifier, etc.

Any melt-blending method may be used for mixing polymeric ingredients and non-polymeric ingredients in the context of the present invention.

For example, polymeric ingredient(s) and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient(s) and non-polymeric ingredients are gradually added in batches, a part of the polymeric ingredient(s) and/or non-polymeric ingredients is first added, and then is melt-mixed with the remaining polymeric ingredient(s) and non-polymeric ingredients that are subsequently added, until an adequately mixed composition is obtained.

If an optional reinforcing agent presents a long physical shape (for example, a long or ‘endless’ fiber), drawing extrusion molding, poltrusion to form long-fiber pellets or poltrusion to form unidirectional composite tapes may be used to prepare a reinforced composition.

### Articles and Applications

Another aspect of the present invention provides the use of the polyamide composition in an article.

The polyamide composition can be desirably incorporated into articles, preferably molded articles. Suitable molded articles include electronic device components, in particular mobile electronic device components.

The article can notably be used in mobile electronics, LED packaging, electrical and electronic components (including, but not limited to, power unit components for computing, data-system and office equipment and surface mounted technology compatible connectors and contacts), medical device components: and electrical protection devices for mini-circuit breakers, contactors, switches and sockets), automotive components, and aerospace components (including, but not limited to, interior cabin components).

The term “mobile electronic device” is intended to denote an electronic device that is designed to be conveniently transported and used in various locations, particularly carried or hand-held by a person. Representative examples of mobile electronic devices may be selected from the group consisting of a mobile electronic phone, a personal digital assistant, a laptop computer, a tablet computer, a radio, a camera and camera accessories, a wearable computing device (e.g., a smart watch, smart glasses and the like), a calculator, a music player, a global positioning system receiver, a portable game console and console accessories, a hard drive and other electronic storage devices. Preferred mobile electronic devices include laptop computers, tablet computers, mobile electronic phones and wearable computing devices, e.g., watches.

Components of mobile electronic devices of interest herein include, but are not limited to, antenna windows, fitting parts, snap fit parts, mutually moveable parts, functional elements, operating elements, tracking elements, adjustment elements, carrier elements, frame elements, switches, connectors, cables, housings, and any other structural part other than housings as used in a mobile electronic devices, such as for example speaker parts. In some embodiments, the device component can be of a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a camera module, a switch, or a switchpad.

The mobile electronic device can be at least a portion of an input device.

A particular aspect of the present invention relates to an electrostatic dissipative component for an electronic device, particularly for a mobile electronic device. Such an electrostatic dissipative component may be a molded article comprising or made from the polyamide composition as described herein.

The mobile electronic device component may also be a mobile electronic device housing. The “mobile electronic device housing” refers to one or more of the back cover, front cover, antenna housing, frame and/or backbone of a mobile electronic device. The housing may be a single article or comprise two or more components. A “backbone” refers to a structural component onto which other components of the device, such as electronics, microprocessors, screens, keyboards and keypads, antennas, battery sockets, and the like are mounted. The backbone may be an interior component that is not visible or only partially visible from the exterior of the mobile electronic device. The housing may provide protection for internal components of the device from impact and contamination and/or damage from environmental agents (such as liquids, dust, and the like). Housing components such as covers may also provide substantial or primary structural support for and protection against impact of certain components having exposure to the exterior of the device such as screens and/or antennas. The mobile electronic device housing may be selected from the group consisting of a mobile phone housing, an antenna housing, an antenna window, a tablet housing, a laptop computer housing, a tablet computer housing or a watch housing.

An electronic device component may include, for example, a radio antenna or a camera module. In this case, the radio antenna can be a WiFi antenna or an RFID antenna. In some such embodiments, at least a portion of the radio antenna is disposed on the polyamide composition. Additionally or alternatively, at least a portion of the radio antenna can be displaced from the polyamide composition.

Any description related to a ‘mobile’ electronic device component is equally applicable to an electronic device component (such as a housing, radio antenna or camera module) which is not ‘mobile’, that is to say, which is part of an electronic device which is not carried or hand-held by a person.

Examples of automotive components include, but are not limited to, components in automotive electronic components, automotive lighting components (including, but not limited to, motor end caps, sensors, ECU housings, bobbins and solenoids, connectors, circuit protection/relays, actuator housings, Li-ion battery systems, and fuse boxes), traction motor and power electronic components (including, but not limited to, battery packs), electrical battery housings.

The article can be molded from the polyamide composition by any process adapted to thermoplastics, e.g., extrusion, injection molding, blow molding, rotomolding, overmolded or compression molding.

Preferred formation of the molded article or the (mobile) electronic device component includes a suitable melt-processing method such as injection molding or extrusion molding of the polyamide composition, injection molding being a preferred shaping method.

In some embodiments, the molded article or the (mobile) electronic device component according to the invention has at least one of the following properties.

The molded article or the (mobile) electronic device component according to the invention may have a volume resistivity of at least 1·10⁺⁵ Ω·cm, or at least 1.5·10⁺⁵ Ω·cm. The molded article or the (mobile) electronic device component according to the invention may have a volume resistivity of at most 5·10⁺¹² Ω·cm, or at most 3·10⁺¹² Ω·cm. In such instance, the molded article or the (mobile) electronic device component may have a volume resistivity of from 1·10⁺⁵ Ω·cm up to 5·10⁺¹² Ω·cm.

The molded article or the (mobile) electronic device component according to the invention may have a mold shrinkage (in %) in transverse direction, determined according to ISO 294 (ASTM D955) of at most 0.5%, or at most 0.47%, or at most 0.45%, or at most 0.44%.

The molded article or the (mobile) electronic device component according to the invention may have a ratio of mold shrinkage in flow direction versus shrinkage in transverse direction is greater than 32%, or greater than 35%, or greater than 40%, or greater than 45%, or greater than 50%, or greater than 55%, or greater than 60%, wherein the mold shrinkages (in %) in flow direction and in transverse direction are determined according to ISO 294 (ASTM D955).

The molded article or the (mobile) electronic device component according to the invention may have a warpage of at most 0.5, or at most 0.4, or at most 0.3, or at most 0.2, or at most 0.18.

### Use of the Polyamide Composition

In some embodiments, the polyamide composition or article can be used for manufacturing a mobile electronic device component, as described above.

Method for Reducing Warpage and/or Mold Shrinkage of a Polyamide Composition

Another aspect of the present invention relates to a method for reducing warpage and/or mold shrinkage of a molded article made from a polyamide composition, comprising blending the polyamide polymer and the electrically conductive material with the glass filler and optional components to form a molding composition before subjecting the molding composition to molding, preferably injection molding to form a molded article. The blending is preferably carried out by melt-blending as described above.

### Method for Reducing Volume Resistivity of a Polyamide Composition

Another aspect of the present invention relates to a method for reducing volume resistivity of a molded article made from a polyamide composition, comprising blending the polyamide polymer and the glass filler and optional components with the conductive material to form a molding composition before subjecting the molding composition to molding, preferably injection molding to form a molded article. The blending is preferably carried out by melt-blending as described above.

### EXAMPLES

The invention will now be described with reference to the following examples, whose purpose is merely illustrative and not intended to limit the scope of the invention. As used in the Examples, “E” denotes an example embodiment of the present invention and “CE” denotes a counter-example.

The examples demonstrate improved warpage and/or mold shrinkage and CLTE (for dimensional stability), and a reduction in volume resistivity of the polyamide compositions according to the invention.

### Raw Materials

The raw materials used to form the samples as provided below:
Polyamide 1 (“PA1”): PA6,10 (Tg=50-60° C., Tm=220° C.) as Radipol DC 40 from Radici
Polyamide 2 (“PA2”): PA10T/10I (Tg=105° C., Tm=295° C.) as Vicnyl 6100 from Kingfa
Glass Flakes (“GFla”): MEG160FY-M03, from NEG
Glass Fiber (“GFib1”)—CSG3PA flat fiber E glass, from Nittobo
Glass Fiber (“GFib2”)—HM435TM round S-1 glass, from Taishan
Electrically Conductive Material (“CM1”): APPLY CARBON chopped Carbon Fibers CF.OS.U1—6 MM, from Procotex
Optional Electrically Conductive Material (“CM2”): carbon black concentrate (30 wt % Black Pearls 800 carbon black, 70 wt % PAMXD6 as polymeric carrier) commercially available as IXEF® 0316/0000; A15560; from Colloids Limited
Electrically Conductive Material (“CM3”): masterbatch of 15 wt % FIBRIL® multi-walled carbon nanotubes from Hyperion Catalysis International in polymeric carrier: PAMXD6 ‘7003’ from Mitsubishi Gas Chemical Co.
Electrically Conductive Material (“CM4”): masterbatch of 10 wt % Nanocyl® NC7000 multi-walled carbon nanotubes in polymeric carrier: PAMXD6 ‘7003’ from Mitsubishi Gas Chemical Co.
Electrically Conductive Material (“CM5”): 300-micron milled carbon fibers in granulates, commercially available as APPLY CARBON CF MLD 300 G U1 recycled carbon fiber granulate from Procotex; characterized by a mean size of about 300 ±40 microns, a carbon content of about 94 wt %, a mono-filament fiber's diameter of about 7 ±2 microns, and an average volume resistivity of 15·10⁻³ ohm·m.
Additives: Additive package 1 (“AP1”) containing 0.1 wt % of a lubricant (calcium stearate Ceasit I from Baerlocher) and 0.2 wt % of a heat stabilizer (Irganox® B1171 from BASF)
Additives: Additive package 2 (“AP2”) containing 0.1 wt % of a lubricant (calcium stearate Ceasit I from Baerlocher), 0.3 wt % of a UV stabilizer (Chimassorb 944 LD from BASF) and 0.2 wt % of a heat stabilizer (Irganox® B1171 from BASF)
Optional additives: pigments/dyes may be added to the polyamide compositions.

### Test Methods

Tensile properties—ISO 527
   Tensile modulus, strength, and strain were measured on 5 injection molded ISO Type 1a tensile specimens (total length=170 mm, gauge length=50 mm, testing section width=10 mm, and thickness=4 mm)
Notched Izod impact strength—ASTM D256
   Notched Izod impact strength was measured in J/m on 5 injection molded, rectangular bars having dimensions of 3.2 mm thickness by 12.7 mm width by 125 mm length.
Unnotched Izod impact strength—ASTM D4812
   Unnotched Izod impact strength was measured in J/m on 5 injection molded, rectangular bars having dimensions of 3.2 mm thickness by 12.7 mm width by 125 mm length.
In some instances, Izod impact strength properties (notched-Izod, un-notched-Izod) were measured in kJ/m² using ISO 180 using 10 injection molded ISO type 1A bars (length of 80±2 mm, width of 10±0.2 mm, thickness of 4±0.2 mm).
CLTE—ASTM E831
   The dimensional changes were measured on injection molded specimens having dimensions of 3.2 mm thickness by 12.7 mm width by 12.0 to 13.0 mm length. A TMA was used to measure the CLTE from 0° C. to 50° C. with a heating rate of 5° C./min in the flow and transverse directions.
Mold shrinkage—ISO 294 (ASTM D955)
   Mold shrinkage (mold shrinkage in Flow Direction (%) and in Transverse Direction (%)) was measured on 5 injection molded plaques with dimensions 60 mm width by 60 mm length by 2 mm thick.
Warpage is determined as follows: polyamide compositions were injection molded into plaques having dimensions of 60 mm×60 mm×2 mm according to ASTM D955, as detailed above. The warpage was calculated as the absolute value of the percent shrinkage in the transverse direction minus the percent shrinkage in the flow direction.
Volume resistivity—ASTM D257
   Volume resistivity was measured on 5 injection molded plaques with dimensions 4″×4″×⅛ (length×width×thickness) or 60 mm×60 mm×2 mm (length×width×thickness)
Surface resistivity—ASTM D257
   Surface resistivity was measured on 5 injection molded plaques with dimensions 4″×4″×⅛ (length×width×thickness)

### Example 1—Polyamide Compositions With PA6,10

In this example, several samples of polyamide compositions were prepared in which PA1 (PA6,10) was compounded (melt-blended) with carbon fibers, optionally carbon black concentrate, additive package 1, and glass flakes (GFla).

Samples E1 and E2 contained 44. 7 wt % of PA1, 10 wt % carbon fibers, and 45 wt % glass flakes. Sample E2 further contained 10 pph of carbon black concentrate, while Sample E1 did not contain any carbon black concentrate.

For comparison, Sample CEO containing 89.7 wt % PA1, 10 wt % carbon fibers, but without glass flakes, was prepared. Samples CE1, CE2 containing 49. 7 wt % PA1, 50 wt % of the glass flakes and either 1 or 10 pph of carbon black concentrate (but no carbon fibers) were also prepared. Samples CE3 and CE4 contained 44. 7 wt % of PA1, 50 wt % glass flakes, and either 1 or 10 pph of carbon black concentrate, but with 5 wt % carbon fibers, a content half than that used in Samples E1 and E2.

The melt-blending was carried out using a Coperion® ZSK-26 co-rotating twin-screw extruder and the compounded samples were subsequently molded according to ASTM D3641.

Table 1 displays the polyamide compositions and also the following properties: the surface and volume resistivity, the mechanical properties including impact properties, the CLTE (0-50° C.) properties (ppm in flow direction and in transverse direction) and mold shrinkage properties (in/in % in flow direction and in transverse direction) of the compositions.

As shown in Table 1, the addition of 10 wt % of carbon fibers to the polyamide composition in Samples E1, E2 decreased the volume resistivity and also surface resistivity compared to Samples CE1 and CE2 without carbon fibers and to Samples CE3 and CE4 with 5 wt % of the same carbon fibers. The Samples E1, E2 were electrostatic dissipative because their volume resistivity fell within the range of 10⁺⁵ to 5·10⁺¹² ohm·cm.

Introducing only 10 wt % of carbon fiber into the PA1 also did not achieve a volume resistivity within the ESD range as can be seen in Sample CEO compared to Samples E1, E2. A combination of glass flakes (insulating filler) and carbon fibers was required to produce an ESD material.

TABLE 1
Compositions and Properties of Samples with PA6,10

| Component | CE0 | CE1 | CE2 | CE3 | CE4 | E1 | E2 |
|---|---|---|---|---|---|---|---|
| PAI (wt %) | 89.7 | 49.7 | 49.7 | 44.7 | 44.7 | 44.7 | 44.7 |
| GFla (wt %) | — | 50 | 50 | 50 | 50 | 45 | 45 |
| CM1 (wt %) | 10 | — | — | 5 | 5 | 10 | 10 |
| CM2 (pph*) | — | 1 | 10 | 1 | 10 | — | 10 |
| AP1 (wt %) | 0.3 | 0.3 | 0.3 | 0.3 | 0.3 | 0.3 | 0.3 |

Properties

| | | | | | | | |
|---|---|---|---|---|---|---|---|
| Surf. Resistivity | | 1.1 | | 1 | | | 2.4 |
| (ohm/square) | | 10⁺¹⁶ | | 10⁺¹⁶ | | | 10⁺⁰⁷ |
| Vol. Resistivity | 3.1 | 1.7 | 2.3 | 6.6 | 6.9 | 2.1 | 3.1 |
| (ohm · cm) | 10⁺¹³ | 10⁺¹⁶ | 10⁺¹⁶ | 10⁺¹⁵ | 10⁺¹⁵ | 10⁺¹² | 10⁺⁰⁷ |
| Thickness (mm) | | 1.599 | | 1.637 | | | 1.63 |
| Notched Impact | 155 | 55 | | 62 | | | 61 |
| (J/m) | | | | | | | |
| Un-notched Impact | 2073 | 710 | | 731 | | | 704 |
| (J/m) | | | | | | | |
| CLTE (ppm) in | | 24 | 27 | 19 | 17 | 41 | 17 |
| Flow Direction | | | | | | | |
| CLTE (ppm) in | | 50 | 47 | 49 | 45 | 54 | 43 |
| Transverse | | | | | | | |
| Direction | | | | | | | |
| Shrinkage (in/in, %) | | 0.354 | 0.31 | 0.343 | 0.32 | 0.32 | 0.34 |
| in Flow direction | | | | | | | |
| Shrinkage (in/in, %) | | 0.478 | 0.38 | 0.425 | 0.38 | 0.39 | 0.43 |
| in transverse | | | | | | | |
| direction | | | | | | | |
| Shrinkage Ratio (%, | | 74.1% | 81.6% | 80.7% | 84.2% | 82.1% | 79.1% |
| flow/transv.) | | | | | | | |
| Warpage | | 0.124 | 0.07 | 0.082 | 0.06 | 0.07 | 0.09 |
| Modulus of | 8.9 | 14.6 | 13.7 | 20.1 | 18.0 | 22.0 | 21.8 |
| Elasticity (GPa) | | | | | | | |
| Tensile Stress at | 160 | 154 | 147 | 193 | 174 | 202 | 214 |
| break | | | | | | | |
| Tensile Elongation | 3.8 | 2.4 | 2.0 | 2.1 | 2.0 | 2.3 | 2.0 |
| at break (%) | | | | | | | |

*“pph” means parts per hundred by total weight of PA + GFla + AP1 + CM1 + CM2 (when present)

The combination of 10 wt % of carbon fibers and carbon black in the polyamide composition in Sample E2 decreased the volume resistivity by 5-order of magnitude compared to Sample E1 which contains 10 wt % carbon fibers without IXEF® carbon black concentrate. However this effect was not observed for Samples CE2 (without CM1) and CE4 (with 5 wt % CM1) which had 10 pph IXEF® carbon black concentrate compared to Samples CE1 (without CM1) and CE2 (with 5 wt % CM1) which only had 1 pph IXEF® carbon black concentrate. Therefore if the carbon fibers were not present in sufficient amount in the PA1-based compositions to achieve a volume resistivity of at most 5·10⁺¹² ohm·cm (to be within ESD volume resistivity range), the addition of 1-10 pph IXEF® carbon black concentrate was not effective in reducing the volume resistivity for the PA1-based compositions to be suitable for ESD.

The addition of 5 wt % of carbon fibers to the polyamide composition in Sample CE3 slightly decreased the volume resistivity but not the surface resistivity compared to Sample CE1 without carbon fibers. At any rate, the volume resistivity with Sample CE3 was still too high to be within ESD volume resistivity range.

Moreover, the modulus of elasticity and tensile stress at break of Samples E1, E2 with 10 wt % of carbon fibers were improved compared with Samples CE3, CE4 with 5 wt % of carbon fibers and even better than with Samples CE1, CE2 without carbon fibers.

The tensile elongation at break (%) of Samples E1, E2 with 10 wt % of carbon fibers were either the same or better compared with Samples CE1, CE2 without carbon fibers and Samples CE3, CE4 with 5 wt % of carbon fibers.

Furthermore, the mold shrinkage properties were more isotropic with the addition of glass flakes for all PA1-based compositions in Table 1. The ratios of shrinkage in flow direction versus in transverse direction were from 74% to 82%, very close to isotropic shrinkage. Despite the addition of 10 wt % CM1, the transverse mold shrinkage of the polyamide composition in Samples E1, E2 remained relatively unchanged compared to Samples CE1 to CE4, indicating that the addition of 10 wt % CM1 did not adversely impact the transverse mold shrinkage.

The presence of carbon black seemed to slightly decrease transverse mold shrinkage of the PA1-based compositions when comparing Sample E2 with Sample E1, Sample CE4 with Sample CE3, and Sample CE2 with Sample CE1.

The results obtained with Samples E1, E2 demonstrated that by the addition of more than 5 wt % carbon fibers (and optionally carbon black) and 45 wt % glass flakes in PA1-based compositions, a suitable ESD material can be obtained while obtaining dimensional stability (maintaining the improved mold shrinkage properties).

### Example 2—Polyamide Compositions With PA10T/10I

In this example, several samples of polyamide compositions were prepared in which PA2 (PA10T/10I) was compounded (melt-blended) with carbon fibers, optionally carbon black concentrate, additive package 1, and glass flakes (GFla).

Samples E3 and E4 contained 44.7 wt % of PA2, 10 wt % carbon fibers, and 45 wt % of glass flakes. Sample E4 further contained 10 pph of carbon black concentrate, while Sample E3 did not contain any carbon black concentrate.

For comparison, Sample CE5 containing 49.7 wt % PA2, 50 wt % of the glass flakes and 10 pph of carbon black concentrate (but no carbon fibers) was also prepared.

Samples CE6 and CE7 contained 44.7 wt % of PA2, 50 wt % glass flakes, and either 1 or 10 pph of carbon black concentrate, but with 5 wt % carbon fibers, a content half of that used in Samples E3 and E4.

The melt-blending was carried out using a Coperion® ZSK-26 co-rotating twin-screw extruder and the compounded samples were subsequently molded according to ASTM D3641.

Table 2 displays the polyamide compositions of Samples E3, E4, CE5, CE6, and also the following properties: the surface and volume resistivity, the mechanical properties, the CLTE (0-50° C.) properties and mold shrinkage properties of the compositions.

### Counter Example 3—Polyamide Compositions With PA10T/10I and Glass Fibers

In this counter-example, several Samples CE8, CE9 were prepared in which PA2 (PA10T/10I) was compounded (melt-blended) with additive package 2 and either 30 wt % of E-glass fibers (GFib1) or with 55 wt % S1-glass fibers (GFib2). These examples were to assess the dimensional instability (by way of mold shrinkage measurement and warpage calculation) using glass fibers compared to glass flakes.

The polyamide compositions and properties of Samples CE8, CE9 are also provided in Table 2.

As shown in Table 2, the addition of 10 wt % of carbon fibers to the polyamide composition in Samples E3, E4 decreased the volume resistivity and also surface resistivity compared to Sample CE5 without carbon fibers and to Samples CE6 and CE7 with 5 wt % of the same carbon fibers. Samples E3, E4 were electrostatic dissipative because their volume resistivity fell within the range of 10⁺⁵ to 5·10⁺¹² ohm·cm. Sample CE5, CE6 and CE7 were not ESD materials.

The combination of 10 wt % of carbon fibers and carbon black in the polyamide composition in Sample E4 decreased the volume resistivity by 1-order of magnitude compared to Sample E3 which contains 10 wt % carbon fibers without carbon black. However this effect was not observed for Sample CE7 (with 5 wt % CM1) which had 10 pph carbon black concentrate compared to Sample CE6 (with 5 wt % CM1) which only had 1 pph carbon black concentrate. Therefore if the carbon fibers were not present in sufficient amount in the PA2-based compositions to achieve a volume resistivity of at most 5·10⁺¹² ohm·cm (to be within ESD volume resistivity range), the addition of 1-10 pph carbon black concentrate was not effective in reducing the volume resistivity for the PA2-based compositions to be suitable for ESD. The volume resistivity obtained with Samples CE6, CE7 (with 5 wt % CM1) was still too high to be within ESD volume resistivity range.

Moreover, the modulus of elasticity of Samples E3, E4 with 10 wt % of carbon fibers were improved compared with Samples CE6, CE7 with 5 wt % of carbon fibers and even better than with Sample CE5 without carbon fibers.

Furthermore, the mold shrinkage was approaching isotropy with the addition of glass flakes in Samples CE5-CE7 and E3-E4 in Table 2. The ratios of mold shrinkage in flow direction versus in transverse direction were ranging from 63% to 78%.

Despite the addition of 10 wt % CM1, the transverse mold shrinkage of the polyamide composition in Sample E3 remained relatively unchanged compared to Samples CE5 to CE7, indicating that the addition of carbon fibers did not negatively impact the transverse mold shrinkage.

TABLE 2
Compositions and Properties of Samples with PA10T/10I

| Component | CE5 | CE6 | CE7 | E3 | E4 | CE8 | CE9 |
|---|---|---|---|---|---|---|---|
| PA2 (wt %) | 49.7 | 44.7 | 44.7 | 44.7 | 44.7 | 44.4 | 69.4 |
| GFla (wt %) | 50 | 50 | 50 | 45 | 45 | — | — |
| GFib1 (wt %) | — | — | — | — | — | — | 30 |
| GFib2 (wt %) | — | — | — | — | — | 55 | — |
| CM1 (wt %) | — | 5 | 5 | 10 | 10 | — | — |
| CM2 (pph*) | 10 | 1 | 10 | — | 10 | — | — |
| AP1 (wt %) | 0.3 | 0.3 | 0.3 | 0.3 | 0.3 | — | — |
| AP1 (wt %) | — | — | — | — | — | 0.6 | 0.6 |

Properties

| | | | | | | | |
|---|---|---|---|---|---|---|---|
| Surface Resistivity | | 2.5 | | | 2.8 | | |
| (ohm/square) | | 10⁺¹⁶ | | | 10⁺⁰⁵ | | |
| Volume Resistivity | 1.22 | 5.2 | 1.24 | 6.74 | 1.7 | | |
| (ohm · cm) | 10⁺¹⁷ | 10⁺¹⁶ | 10⁺¹⁶ | 10⁺⁷ | 10⁺⁰⁵ | | |
| Thickness (mm) | | 1.672 | | | 1.65 | | |
| Notched Impact (J/m) | | 46 | | | 51 | | |
| Un-notched Impact | | 576 | | | 372 | | |
| (J/m) | | | | | | | |
| CLTE (ppm) in flow | 21 | 14 | 18 | 15 | 14 | | |
| direction | | | | | | | |
| CLTE (ppm) in | 40 | 34 | 37 | 38 | 36 | | |
| transverse direction | | | | | | | |
| Shrinkage (in/in, %) | 0.29 | 0.23 | 0.32 | 0.28 | | 0.13 | 0.26 |
| in flow direction | | | | | | | |
| Shrinkage (in/in, %) in | 0.39 | 0.36 | 0.41 | 0.37 | | 0.98 | 0.84 |
| transverse direction | | | | | | | |
| Shrinkage Ratio (%, | 74.4% | 63.9% | 78.0% | 75.7% | | 13.3% | 31.0% |
| flow/transv.) | | | | | | | |
| Warpage | 0.1 | 0.13 | 0.09 | 0.09 | | 0.85 | 0.58 |
| Modulus of Elasticity | 14.5 | 21.5 | 19.0 | 23.6 | 23.0 | 20.4 | 9.9 |
| (GPa) | | | | | | | |
| Tensile Stress at Break | 135 | 189 | 161 | 212 | 181 | 248 | 152 |
| Tensile Elongation at | 1.1 | 1.1 | 1 | 1.30 | 0.95 | 2.2 | 1.9 |
| Break (%) | | | | | | | |

*“pph” means parts per hundred by total weight of PA + GFla ++ AP1 + CM1 + CM2 (when present)

On the other end, the mold shrinkage was anisotropic with the addition of glass fibers in Samples CE8 (55 wt % S1-glass fibers) and CE9 (30 wt % E-glass fibers) as shown in Table 2. The ratios of mold shrinkage in flow direction versus in transverse direction were from 13% and 31%, respectively. It was also observed that the warpage of Samples CE8 (55 wt % S1-glass fibers) and CE9 (30 wt % E-glass fibers) in Table 2 was greater than that observed with the addition of glass flakes in Samples CE5-CE7 and E3-E4.

The results obtained with Samples E3, E4 demonstrated that by the addition of more than 5 wt % carbon fibers (and optionally carbon black) and 45 wt % glass flakes in PA2-based compositions, a suitable ESD material can be obtained while obtaining dimensional stability (low warpage and improved mold shrinkage properties).

### Example 4—Polyamide Compositions With PA6,10

In this example, several samples of polyamide compositions were prepared in which PA1 (PA6,10) was compounded (melt-blended) with carbon nanotubes (as a masterbatch “CM3” or “CM4”)), carbon black concentrate “CM2”, additive package 1, and glass flakes (GFla). The melt-blending was carried out using a Coperion® ZSK-26 co-rotating twin-screw extruder and the compounded samples were subsequently molded according to ASTM D3641.

Samples E5 and E6 contained two different amounts of the carbon nanotubes masterbatch “CM3” as electrically conductive material, resulting in an actual weight content of 2.25 and 3 wt % CNTs, respectively. Samples E7 and E8 contained two different amounts of the carbon nanotubes masterbatch “CM4” as electrically conductive material, resulting in an actual weight content of 1.5 and 2 wt % CNTs in PAMXD6 as polymeric carrier, respectively.

For comparison, Sample CE10 without carbon nanotubes was prepared.

Table 3 displays the polyamide compositions and also the following properties: the surface and volume resistivity, the mechanical properties including impact properties, the CLTE (0-50° C.) properties (ppm in flow direction and in transverse direction) and mold shrinkage properties (in/in % in flow direction and in transverse direction) of the compositions.

TABLE 3
Compositions and Properties of Samples with PA6, 10

| Component | CE10 | E5 | E6 | E7 | E8 |
|---|---|---|---|---|---|
| PA1 (wt %) | 49.7 | 34.7 | 29.7 | 34.7 | 29.7 |
| GFla (wt %) | 50 | 50 | 50 | 50 | 50 |
| CM3 (wt %)- | — | 15 | 20 | — | — |
| CNTs- | | 2.25 | 3 | | |
| PAMXD6 | | 12.75 | 17 | | |
| CM4 (wt %)- | — | — | — | 15 | 20 |
| CNTs- | | | | 1.5 | 2 |
| PAMXD6 | | | | 13.5 | 18 |
| AP1 (wt %) | 0.3 | 0.3 | 0.3 | 0.3 | 0.3 |
| CM2 (pph*) | 1 | 1 | 1 | 1 | 1 |

Properties

| | | | | | |
|---|---|---|---|---|---|
| Surf. Resistivity | 6.25 | 5.78 | 2.15 | 1.93 | 8.36 |
| (ohm/square) | 10⁺¹⁴ | 10⁺⁸ | 10⁺⁹ | 10⁺¹² | 10⁺⁶ |
| Vol. Resistivity | 8.46 | 1.89 | 2.77 | 3.67 | 2.74 |
| (ohm.cm) | 10⁺¹⁵ | 10⁺¹¹ | 10⁺⁷ | 10⁺¹¹ | 10⁺⁸ |
| Thickness (mm) | 2.12 | 1.97 | 2.09 | 2.06 | 1.99 |
| Notched Impact | 5.8 | 5.1 | 5.4 | 5.0 | 4.5 |
| (ISO kJ/m²) | | | | | |
| Un-notched Impact | 46 | 34 | 23 | 29 | 25 |
| (ISO kJ/m²) | | | | | |
| CLTE (ppm) in flow | 24 | — | — | 24 | — |
| direction | | | | | |
| CLTE (ppm) in transverse | 65 | — | — | 50 | — |
| direction | | | | | |
| Shrinkage (in/in, %) in | 0.08 | — | 0.09 | 0.12 | — |
| flow direction | | | | | |
| Shrinkage (in/in, %) in | 0.25 | — | 0.26 | 0.29 | — |
| transverse direction | | | | | |
| Shrinkage Ratio | 32.0% | | 34.6% | 41.4% | — |
| (%, flow/transv.) | | | | | |
| Warpage | 0.170 | — | 0.170 | 0.170 | — |
| Modulus of Elasticity | 13.8 | 16.1 | 17.0 | 15.9 | 16.4 |
| (GPa) | | | | | |
| Tensile Stress at break | 147 | 157 | 155 | 157 | 160 |
| Tensile Elongation at | 2.6 | 1.5 | 1.2 | 1.5 | 1.4 |
| break (%) | | | | | |

*“pph” means parts per hundred by total weight of PA + GFla + AP1 + CM2 + CM3 or CM4

As shown in Table 3, the addition of from 1.5 to 3 wt % of carbon nanotubes (MWCNTs) to the polyamide composition in Samples E5-E8 decreased the volume resistivity and also surface resistivity compared to Sample CE10 without carbon nanotubes. Samples E5-E8 were electrostatic dissipative because their volume resistivity fell within the range of 10⁺⁵ to 5·10⁺¹² ohm·cm. Sample CE10 was not an ESD material.

Although not shown, the addition of less than 1 wt % of carbon nanotubes (MWCNTs) to the polyamide composition did not decrease the volume resistivity below the maximum 5·10⁺¹² ohm·cm value to provide an ESD material.

In order to achieve the minimum volume resistivity of 10⁺⁵ ohm·cm to provide an ESD material, the wt % of carbon nanotubes added to the polyamide composition could be increased above the 3 wt % CNTs content (used in Sample E6), e.g., up to 5 wt % CNTs or up to 6 wt % CNTs, to decrease the volume resistivity by at least about 2 orders of magnitude.

The results obtained with Samples E5-E8 demonstrated that by the addition of from 1.5 to 3 wt % carbon nanotubes and 50 wt % glass flakes in PA1-based compositions, a suitable ESD material can be obtained while obtaining dimensional stability (low warpage and improved mold shrinkage properties).

### Example 5—Polyamide Compositions With PA10T/10I

In this example, Sample E9 of polyamide composition was prepared in which PA2 (PA10T/10I) was compounded (melt-blended) with 10 wt % milled carbon fiber particulates (“CM5”) as electrically conductive material, carbon black concentrate “CM2”, additive package 1, and glass flakes (GFla). The melt-blending was carried out using a Coperion® ZSK-26 co-rotating twin-screw extruder and the compounded samples were subsequently molded according to ASTM D3641.

For comparison, Sample CE11 without milled carbon fibers was prepared.

The polyamide compositions and properties of Samples CE11 and E9 are provided in Table 4.

As shown in Table 4, the addition of 10 wt % of milled carbon fibers (in particulate form) to the polyamide composition in Sample E9 significantly decreased by 10 orders of magnitude the volume resistivity compared to Sample CE11 without milled carbon fibers. Sample E9 was electrostatic dissipative because its volume resistivity fell within the range of 10⁺⁵ to 5·10⁺¹² ohm·cm. Sample CE11 was not an ESD material.

TABLE 4
Compositions and Properties of Samples with PA10T/10I

| Component | CE11 | E9 |
|---|---|---|
| PA2 (wt %) | 49.7 | 39.7 |
| GFla (wt %) | 50 | 50 |
| CM5 (wt %) | — | 10 |
| API (wt %) | 0.3 | 0.3 |
| CM2 (pph*) | 1 | 1 |

Properties

| | | |
|---|---|---|
| Surf. Resistivity (ohm/square) | — | — |
| Vol. Resistivity (ohm.cm) | 4.87 10⁺¹⁶ | 3.24 10⁺⁶ |
| Thickness (mm) | 2.12 | 1.97 |
| Notched Impact | 3.7 | 5.9 |
| (ISO kJ/m²) | | |
| Un-notched Impact | 36.1 | 34.4 |
| (ISO kJ/m²) | | |
| Shrinkage (in/in, %) in flow | 0.3 | 0.27 |
| direction | | |
| Shrinkage (in/in, %) in | 0.43 | 0.30 |
| transverse direction | | |
| Shrinkage Ratio (%, | 70% | 90% |
| flow/transv.) | | |
| Warpage | 0.13 | 0.03 |
| Modulus of Elasticity (GPa) | 14.3 | 24.9 |
| Tensile Stress at break | 146 | 186 |
| Tensile Elongation at break | 0.9 | 1.0 |
| (%) | | |

*“pph” means parts per hundred by total weight of PA + GFla + AP1 + CM2 + CM5

Moreover, the tensile modulus of elasticity and tensile strength of Sample E9 with 10 wt % of milled carbon fibers were improved compared with Sample CE11 without milled carbon fibers. Likewise, notched Izod impact properties were improved with the addition of milled carbon fibers.

Furthermore, the addition of 10 wt % milled carbon fibers did not negatively impact the mold shrinkage and warpage; to the contrary it improved it. The transverse mold shrinkage (0.3%) was greatly improved in Sample E9 compared to Sample CE11 (0.43%). The ratio of mold shrinkage in flow direction versus in transverse direction was 90% compared to 70% in Sample CE11 and the estimated warpage value was decreased from 0.13 (CE11) to 0.03 (E9). The mold shrinkage was approaching isotropy with the addition of 10 wt % of milled carbon fibers in Sample E9.

The results obtained with Sample E9 demonstrated that by the addition of from 10 wt % milled carbon fiber particulate and 50 wt % glass flakes in PA2-based compositions, a suitable ESD material can be obtained while obtaining dimensional stability (low warpage and improved mold shrinkage properties) and maintaining excellent mechanical properties.

While preferred embodiments of this invention have been shown and described, modifications thereof can be made by one skilled in the art without departing from the spirit or teaching of this invention. The embodiments described herein are exemplary only and are not limiting. Many variations and modifications of compositions, articles, and methods are possible and are within the scope of the invention. Accordingly, the scope of protection is not limited by the description set out above, but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. Any incorporation by reference of documents above is limited such that no subject matter is incorporated that is contrary to the explicit disclosure herein.

The disclosure of all patent applications, and publications cited herein are hereby incorporated by reference, to the extent that they provide exemplary, procedural or other details supplementary to those set forth herein. Should the disclosure of any patents, patent applications, and publications which are incorporated herein by reference conflict with the description of the present application to the extent that it may render a term unclear, the present description shall take precedence.

We claim:

1. A polyamide composition comprising:
at least 20 weight percent (wt %) of a polyamide polymer,
from more than 1 wt % and up to 20 wt % of an electrically conductive material comprising carbon fibers, carbon nano-tubes, or any combination thereof, and
from 20 wt % to 60 wt % of a glass filler having tri-dimensional structures characterized by an average length of at most 500 microns, said glass filler comprising at least 20 wt % of glass flakes,
wherein the wt % are based on the total weight of the polyamide composition.

2. The polyamide composition of claim 1, wherein the polyamide polymer comprises a semi-aromatic polyamide.

3. The polyamide composition of claim 1, wherein the polyamide polymer comprises a semi-aromatic polyamide selected from the group consisting of PA10T/10I; PA10T; PA6T/6I; PA6T; PA9T; PA12T; PA10T/66; PA6T/66; PA6,I; PA12I; PAMXD6; PAPXD10; and any combination thereof.

4. The polyamide composition of claim 1, wherein the polyamide polymer comprises an aliphatic polyamide selected from the group consisting of PA610; PA612; PA10/10; PA12; PA510; PA66; PA10/12; and any combination thereof.

5. The polyamide composition of claim 1, wherein the glass filler further comprises chopped round or flat glass fibers.

6. The polyamide composition of claim 1, wherein the glass filler comprises from 30 wt % to 55 wt % of glass flakes, based on the total weight of the polyamide composition.

7. The polyamide composition of claim 1, wherein the electrically conductive material comprises chopped carbon fibers, milled carbon fibers, milled/chopped carbon fibers in granulates, single-walled carbon nano-tubes (SWCNTs), double-walled carbon nanotubes (DWCNTs), multi-walled carbon nanotubes (MWCNTs), or any combination thereof.

8. The polyamide composition of claim 1, wherein the electrically conductive material further comprises carbon black powder.

9. The polyamide composition of claim 1, wherein the electrically conductive material further comprises carbon-based tri-dimensional structures selected from the group consisting of flakes, powders, microspheres, nano-particles, nano-fibers, nano-flakes, nano-ropes, nano-ribbons, nano-fibrils, nano-needles, nano-sheets, nano-rods, carbon nano-cones, carbon nano-scrolls, nano-platelets, nano-dots, dendrites, discs or any other tri-dimensional body, singly or in combination.

10. The polyamide composition of claim 1, wherein the electrically conductive material has a volume resistivity, measured according to ASTM D257, of less than 2·10⁻² Ω·cm.

11. The polyamide composition of claim 1, being electrostatic dissipative.

12. A method for making the polyamide composition of claim 1, comprising melt-blending the polyamide polymer, the electrically conductive material, the glass filler and any optional additives selected from the group consisting of another reinforcing agent different than the glass filler, tougheners, plasticizers, light stabilizers, ultra-violet stabilizers, heat stabilizers, pigments, dyes, antistatic agents, flame retardants, impact modifiers, lubricants, nucleating agents, antioxidants, processing aids, and any combination of two or more thereof.

13. A molded article comprising the polyamide composition of claim 1.

14. A mobile electronic device component comprising the polyamide composition of claim 1.

15. The molded article of claim 13, having at least one of the following properties:
a volume resistivity, measured according to ASTM D257, of from 1·10⁺⁵ Ω·cm up to 5·10⁺¹² Ω·cm;
a ratio of mold shrinkage in flow direction versus mold shrinkage in transverse direction greater than 32%, wherein the mold shrinkages (in %) in flow direction and in transverse direction are determined according to ISO 294 (ASTM D955);
a warpage of at most 0.5; and/or
a mold shrinkage (in %) in transverse direction, determined according to ISO 294 (ASTM D955), of at most 0.5%.

16. The mobile electronic device component of claim 14, having at least one of the following properties:
a volume resistivity, measured according to ASTM D257, of from 1·10⁺⁵ Ω·cm up to 5·10⁺¹² Ω·cm;
a ratio of mold shrinkage in flow direction versus mold shrinkage in transverse direction greater than 32%, wherein the mold shrinkages (in %) in flow direction and in transverse direction are determined according to ISO 294 (ASTM D955);
a warpage of at most 0.5; and/or
a mold shrinkage (in %) in transverse direction, determined according to ISO 294 (ASTM D955), of at most 0.5%.

17. The polyamide composition of claim 1, wherein the electrically conductive material comprises at least 6 wt % of carbon fibers, more than 1 wt % of carbon nano-tubes, or any combination thereof, said wt % being based on the total weight of the polyamide composition.
